(19) United States
(12) Patent Application Publication
(10) Pub. No.: US 2026/0119941 A1
(43) Pub. Date: Apr. 30, 2026

(54) Circuit Cutting With QEM-On-The-Go

(71) Applicant: Dell Products L.P., Round Rock, TX (US)

(72) Inventors: Rômulo Teixeira de Abreu PINHO, Niterói (BR); Miguel Paredes QUIÑONES, Campinas (BR); Micael Veríssimo de ARAÚJO, Rio de Janeiro (BR); João Victor da Fonseca PINTO, Rio de Janeiro (BR)

(21) Appl. No.: 18/926,135

(22) Filed: Oct. 24, 2024

(51) Int. Cl. G06N 10/40; G06N 10/70

(52) U.S. Cl. CPC G06N 10/40; G06N 10/70

(57) ABSTRACT

One example method includes performing, on a quantum circuit, a circuit cutting process to generate a set of subcircuits of the quantum circuit, for each of the subcircuits, (1) running the subcircuit on a target backend quantum hardware configuration, and measuring a noisy output resulting from the running of the subcircuit, (2) using an ML (machine learning) model to obtain an estimate of a noise-free output of the subcircuit, and (3) replacing noisy output of the subcircuits with the estimated noise-free output generated by the ML model. The method further includes running a circuit knitting process, using the estimates, to knit the subcircuits together to form the quantum circuit, and executing the quantum circuit that resulted from the circuit knitting process.

### TECHNOLOGICAL FIELD OF THE DISCLOSURE

Embodiments disclosed herein generally relate to quantum computing. More particularly, at least some embodiments relate to systems, hardware, software, computer-readable media, and methods, for quantum cutting and knitting, with error mitigation.

### BACKGROUND

Circuit cutting is a strategy that can be used to divide a large quantum circuit into small subcircuits which can be executed alone because quantum computers have limitations on the depth and number of qubits. Once executed, the results need to be merged by a classical postprocessing, or knitting, operation. Cutting and knitting are inherently classical operations within the quantum pipeline.

One of the main limiting factors in quantum computing is the presence of noise across the system. In addition to the probabilistic nature of quantum computations, noise augments and exacerbates the inherent non-determinism of quantum circuit results. The accumulation of noise through the knitting operations may render the final results of the original circuit unusable.

To mitigate noise, different mechanisms for reducing it exist. One of them, referred to as Quantum Error Mitigation (QEM) is a post-processing step implemented via classical algorithms that, typically, assumes a noise model associated with a given piece of quantum hardware and tries to revert the observed noise from such models. QEM could be combined with circuit cutting and knitting to improve the results of the overall quantum circuit execution.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a quantum circuit cutting process.

FIG. 2 discloses aspects of a method according to one embodiment.

FIG. 3 discloses aspects of a computing entity configured and operable to perform, at least, the classical computing methods, processes, and operations disclosed herein.

### DETAILED DESCRIPTION OF SOME EXAMPLE EMBODIMENTS

Embodiments disclosed herein generally relate to quantum computing. More particularly, at least some embodiments relate to systems, hardware, software, computer-readable media, and methods, for quantum cutting and knitting, with error mitigation.

One or more example embodiments are directed to a method, or methods, for integrating between ML-QEM (machine learning-quantum error mitigation) and circuit/knitting process to improve quantum algorithm results. Such methods may avoid the need for additional circuit executions for the QEM process to remove noise prior to knitting. As well, such methods may avoid the need for running QEM on the combined O(2^{N}) output of the original circuit.

One such method, which may be performed by a combination of classical, and quantum, computing hardware, may comprise operations including: performing, on a quantum circuit, a circuit cutting to generate a set of subcircuits of the quantum circuit; defining an empty set; for each of the subcircuits: running the subcircuit on a target backend quantum hardware configuration, and measuring a resulting noisy output; using an ML model to obtain a noise-free output of the subcircuit; and, storing the noise free output in the empty set; running a circuit knitting process, using the stored noise free estimates, to knit the subcircuits together to form the quantum circuit; and, executing the quantum circuit resulting from the circuit knitting process.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that noise may be reduced, or eliminated, in a quantum circuit execution process. An embodiment may avoid the need for additional circuit executions for the QEM process to remove noise prior to knitting. An embodiment may avoid the need for running QEM on the combined O(2^{N}) output of the original circuit. Various other advantages of one or more example embodiments will be apparent from this disclosure.

### A. Reference Documents

Reference is made herein to various documents, listed below. These documents are incorporated herein in their respective entireties by this reference. Reference to these documents should not be construed as an admission or characterization of any kind.
[1] Z. Cai et al., “Quantum Error Mitigation,” Rev. Mod. Phys., vol. 95, no. 4, p. 045005, December 2023, doi: 10.1103/RevModPhys.95.045005.
[2] H. Liao, D. S. Wang, I. Sitdikov, C. Salcedo, A. Seif, and Z. K. Minev, “Machine Learning for Practical Quantum Error Mitigation.” arXiv, Sep. 29, 2023. Accessed: Jan. 31, 2024. [Online]. Available: http://arxiv.org/abs/2309.17368.
[3] U.S. patent application Ser. No. 18/884,005, entitled “QUANTUM ERROR MITIGATION WITH DIFFUSION MODELS,” and filed 12 Sep. 24.
[4] W. Tang, T. Tomesh, M. Suchara, J. Larson, and M. Martonosi, “CutQC: using small Quantum computers for large Quantum circuit evaluations,” in Proceedings of the 26th ACM International Conference on Architectural Support for Programming Languages and Operating Systems, Virtual USA: ACM, April 2021, pp. 473-486. doi: 0.1145/3445814.3446758.

### B. Aspects of an Example Operating Context for One Embodiment

The following is a discussion of aspects of an example context for various embodiments. This discussion is not intended to limit the scope of any claims or this disclosure, or the applicability of the embodiments, in any way.

Due to the inherent noise within quantum systems, combining the results of quantum sub-circuit executions might render the final result unusable due to the accumulation of errors, or noise, from each such execution. Typical QEM solutions require several additional executions of a quantum circuit for the noise of the target quantum system to be modelled and potentially removed, as disclosed in [1]. Moreover, applying QEM to the end result of the algorithm, that is, after sub-circuit knitting has been completed, is potentially more costly because of the O(2^{N}) complexity of the quantum output, where N is the number of qubits of the algorithm. Also after the cutting algorithm is performed, an exponential amount of circuits will be generated and QEM will have to be applied in every circuit generated.

### C. Detailed Discussion

### C.1 Introduction

Machine learning methods have been employed in the QEM space as alternatives to traditional methods. See [2] and [3]. Their benefit lies especially in the fact that an estimate of the noise-free output of a circuit can be obtained without additional circuit executions and without assumptions about the noise model of quantum hardware. In view of these, and other, considerations, one or more embodiments address limitations of the combination between QEM and circuit cutting by leveraging machine learning in the QEM process.

### C.2 Discussion

One or more embodiments leverage a ML-QEM method, such as disclosed in [3]. In that method, a machine learning model is trained to predict the noise-free output O_{f} of a quantum circuit c by taking as input the circuit in the form of a DAG (directed acyclic graph), characteristics of the quantum hardware Q where the circuit is executed, and the measured noisy output Oₙ of the circuit. The model M(c, Q, Oₙ), when probed at inference time, yields a noise estimate O_{f′}, of O_{f}, which can be used for analysis or other computation steps.

In an example circuit cutting scheme according to one embodiment, one part of the larger circuit generates multiple variations of the same subcircuit with different input and output bases for each variation of the subcircuit. Since Oₙ, O_{f′}, and O_{f} contain different channels as the variations of the input and output basis for one specific qubit, that can then be treated as an image. An embodiment may incorporate this approach because all of the circuits share the same subcircuit with only small variations.

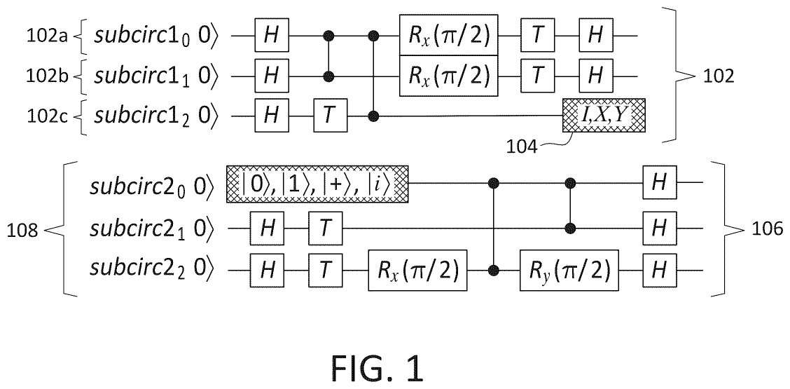

With attention now to FIG. 1, it can be seen that a circuit, or subcircuit, may generate multiple similar subcircuits. In the example of FIG. 1,

For example, in FIG. 1, a subcircuit1 102 may generate three similar subcircuits 102a, 102b, and 102c, each with slightly different respective outputs due to the projections of qubit subcirc1₂ onto the I, X, and Y basis 104. As another example, subcircuit2 106 will generate four similar subcircuits 108 with slightly different inputs on qubit subcirc2₀. An embodiment, each subcircuit may be treated as independent from the others for the purposes of QEM. Further, in an embodiment, even in a standard circuit cutting procedure, each subcircuit variation may be run independently from the others. Thus, an embodiment may operate to apply the ML-QEM method to the output of each independent execution of a subcircuit.

In one embodiment, the training of the ML-QEM approach may be similar, or identical, to the approach disclosed in [3], but with modifications to support the subcircuit variations described above. Further details are now provided concerning one such embodiment.

In particular, an embodiment may begin from a large database of quantum circuits C. For each of the quantum circuits, an embodiment randomly selects a qubit and a layer, and then performs a synthetic cut at the selected point, as illustrated by the example of FIG. 1, thus generating two synthetic subcircuits.

For each of the subcircuits thus generated, an embodiment may then generate variations with the output and input operations described in connection with FIG. 1, so as to produce three circuits for the first part, related to the output, and four circuits for the second part, related to the inputs. An embodiment may then aggregate all these synthetic subcircuits into a large dataset D comprising tuples (c, Q, Oₙ, O_{f}), where Oₙ is obtained by running c on Q and O_{f} is obtained by executing c on an ideal, that is, noise-free, quantum simulation engine running on some classical computing infrastructure.

Next, training of an ML (machine learning) model may be performed, as disclosed in [3] for example. Namely, through an iterative optimization process, a model M tries to minimize the aggregate differences between O_{f} (noise-free output) and the noise estimates O_{f′}=M(c, Q, Oₙ) across the dataset. In [3], for example, M was implemented using a diffusion modelling approach, which is a denoising mechanism that may be used in photorealistic (text-to) image generators.

### C.2.1 Aspects of an Example Embodiment of a Method

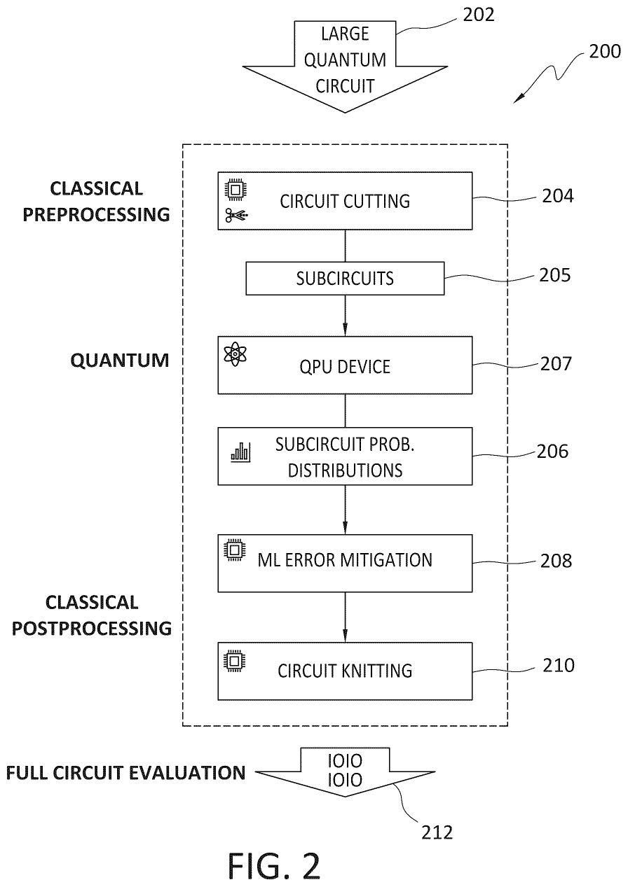

One embodiment may assume the availability of a trained ML model M, such as the one described above. With reference now to FIG. 2, and given a new large quantum circuit c 202 to be executed on some quantum backend Q, a method 200 according to one embodiment—which may be performed using a combination of classical computing infrastructure and quantum computing infrastructure—may proceed as follows:
[a] run a circuit cutting algorithm 204, an example of which is disclosed in [4], on c to generate a set C of subcircuits 205;
[b] define an empty set O_{f′}={ }
[c] for each subcircuit cᵢ in C:
   [i] run cᵢ on a given target backend Q 207 and measure 206 a noisy output Oₙᵢ; and
   [ii] probe the model 208 to obtain O_{f′i}=M(cᵢ, Q, Oₙᵢ) and store O_{f′i} in set O_{f′};
[d] run the circuit knitting algorithm 210, an example of which is disclosed in [4], using the noise-free estimates in O_{f′}; and
[e] obtain 212 the final result of c.

### C.3 Further Discussion

As disclosed herein, one or more embodiments may comprise various useful aspects and features, although no embodiment is required to possess any of such features and aspects. The following examples are illustrative, but not exhaustive.

For example, an embodiment may provide integration between ML-QEM and circuit/knitting process to improve quantum algorithm results. An embodiment may provide avoidance of additional circuit executions for the QEM process to remove noise prior to knitting. As a final example, an embodiment may enable avoidance of running QEM on the combined O(2^{N}) output of the original circuit.

By way of contrast with one or more embodiments, conventional approaches fail to disclose the combination of QEM with circuit cutting and knitting. This is probably because traditional, that is, non-ML, QEM approaches can incur prohibitive costs in terms of processing and expense, in addition to the already costly cutting/knitting process, due to the required additional circuit executions. On the other hand, an embodiment combining the use of ML-QEM methods enables the integration of the two processes in an efficient and effective manner.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method, comprising: performing, on a quantum circuit, a circuit cutting process to generate a set of subcircuits of the quantum circuit; for each of the subcircuits: running the subcircuit on a target backend quantum hardware configuration, and measuring a noisy output resulting from the running of the subcircuit; using an ML (machine learning) model to obtain an estimate of a noise-free output of the subcircuit; and replacing noisy output of the subcircuits with the estimated noise-free output generated by the ML model; running a circuit knitting process, using the estimates, to knit the subcircuits together to form the quantum circuit; and executing, on the backend quantum hardware configuration, the quantum circuit that resulted from the circuit knitting process.

Embodiment 2. The method as recited in any preceding embodiment, wherein a need to perform error mitigation after the circuit knitting process is substantially reduced relative to what the error mitigation would be in a circumstance in which the ML model is not used.

Embodiment 3. The method as recited in any preceding embodiment, wherein no error mitigation is required for the subcircuits prior to performance of the circuit knitting process.

Embodiment 4. The method as recited in any preceding embodiment, wherein an output of the quantum circuit, that was executed after performance of the circuit knitting process, has a lower noise than if the ML model had not been used.

Embodiment 5. The method as recited in any preceding embodiment, wherein the ML model implements a diffusion modelling approach.

Embodiment 6. A system, comprising hardware and/or software, operable to perform any of the operations, methods, or processes, or any portion of any of these, disclosed herein.

Embodiment 7. A non-transitory storage medium having stored therein instructions that are executable by one or more hardware processors to perform operations comprising the operations of any one or more of embodiments 1-5.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Aspects of one or more embodiments may be performed with quantum computing hardware, and/or quantum computing hardware that is simulated on classical computing hardware. Quantum computing hardware may comprise, but is not limited to, annealers and other solvers. One embodiment of a method may be performed using a combination of quantum hardware and classical computing hardware.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

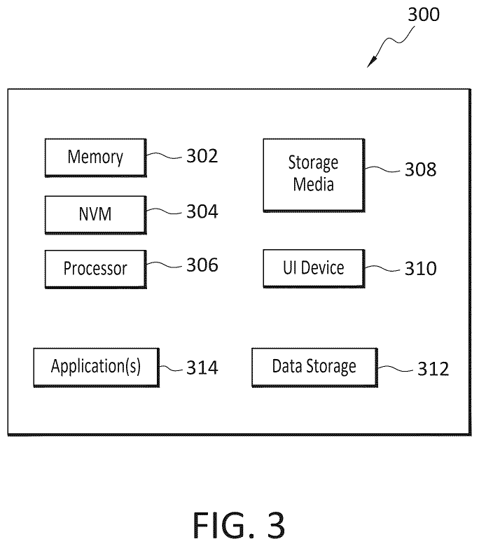

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
performing, on a quantum circuit, a circuit cutting process to generate a set of subcircuits of the quantum circuit;
for each of the subcircuits:
running the subcircuit on a target backend quantum hardware configuration, and measuring a noisy output resulting from the running of the subcircuit;
using an ML (machine learning) model to obtain an estimate of a noise-free output of the subcircuit; and
replacing noisy output of the subcircuits with the estimated noise-free output generated by the ML model;
running a circuit knitting process, using the estimates, to knit the subcircuits together to form the quantum circuit; and
executing, on the backend quantum hardware configuration, the quantum circuit that resulted from the circuit knitting process.

2. The method as recited in claim 1, wherein a need to perform error mitigation after the circuit knitting process is substantially reduced relative to what the error mitigation would be in a circumstance in which the ML model is not used.

3. The method as recited in claim 1, wherein no error mitigation is required for the subcircuits prior to performance of the circuit knitting process.

4. The method as recited in claim 1, wherein an output of the quantum circuit, that was executed after performance of the circuit knitting process, has a lower noise than if the ML model had not been used.

5. The method as recited in claim 1, wherein the ML model implements a diffusion modelling approach.

6. A non-transitory storage medium having stored therein instructions that are executable by one or more hardware processors to perform operations comprising:
performing, on a quantum circuit, a circuit cutting process to generate a set of subcircuits of the quantum circuit;
for each of the subcircuits:
running the subcircuit on a target backend quantum hardware configuration, and measuring a noisy output resulting from the running of the subcircuit;
using an ML (machine learning) model to obtain an estimate of a noise-free output of the subcircuit; and
replacing noisy output of the subcircuits with the estimated noise-free output generated by the ML model;
running a circuit knitting process, using the estimates, to knit the subcircuits together to form the quantum circuit; and
executing, on the backend quantum hardware configuration, the quantum circuit that resulted from the circuit knitting process.

7. The non-transitory storage medium as recited in claim 6, wherein a need to perform error mitigation after the circuit knitting process is substantially reduced relative to what the error mitigation would be in a circumstance in which the ML model is not used.

8. The non-transitory storage medium as recited in claim 6, wherein no error mitigation is required for the subcircuits prior to performance of the circuit knitting process.

9. The non-transitory storage medium as recited in claim 6, wherein an output of the quantum circuit, that was executed after performance of the circuit knitting process, has a lower noise than if the ML model had not been used.

10. The non-transitory storage medium as recited in claim 6, wherein the ML model implements a diffusion modelling approach.

11. A system, comprising:
one or more hardware processors; and
a non-transitory storage medium having stored therein instructions that are executable by the one or more hardware processors to perform operations comprising:
performing, on a quantum circuit, a circuit cutting process to generate a set of subcircuits of the quantum circuit;
for each of the subcircuits:
running the subcircuit on a target backend quantum hardware configuration, and measuring a noisy output resulting from the running of the subcircuit;
using an ML (machine learning) model to obtain an estimate of a noise-free output of the subcircuit; and
replacing noisy output of the subcircuits with the estimated noise-free output generated by the ML model;
running a circuit knitting process, using the estimates, to knit the subcircuits together to form the quantum circuit; and
executing, on the backend quantum hardware configuration, the quantum circuit that resulted from the circuit knitting process.

12. The system as recited in claim 11, wherein a need to perform error mitigation after the circuit knitting process is substantially reduced relative to what the error mitigation would be in a circumstance in which the ML model is not used.

13. The system as recited in claim 11, wherein no error mitigation is required for the subcircuits prior to performance of the circuit knitting process.

14. The system as recited in claim 11, wherein an output of the quantum circuit, that was executed after performance of the circuit knitting process, has a lower noise than if the ML model had not been used.

15. The system as recited in claim 11, wherein the ML model implements a diffusion modelling approach.
